(19) United States
(12) Patent Application Publication
(10) Pub. No.: US 2003/0134196 A1
(43) Pub. Date: Jul. 17, 2003

(54) Non-aqueous organic secondary battery

(76) Inventors: Show-An Chen, Hsinchu (TW); Kai-Min Liang, Taipei (TW); Lan-Sheng Yang, Tianjin (CN); Jen-Jeh Lee, Taipei (TW)

Correspondence Address: FISH & RICHARDSON PC, 225 FRANKLIN ST, BOSTON, MA, 02110, US

(21) Appl. No.: 10/264,274

(22) Filed: Oct. 3, 2002

(30) Foreign Application Priority Data
Oct. 5, 2001 (TW) 90124646

(51) Int. Cl. H01M 4/60; H01M 4/62; H01M 4/66; H01M 4/40; H01M 4/42; H01M 4/58

(52) U.S. Cl. 429/213; 429/232; 429/245; 429/217; 429/326; 429/331; 429/338; 429/339; 429/340; 429/332; 429/231.95; 429/231.4; 429/229

(57) ABSTRACT

A non-aqueous secondary organic battery. The battery includes an positive electrode of polyaniline-conductive carbon black composite (PAn-C composite). The PAn-C composite is prepared using a high-speed impingment mill with high-speed fluid striking and grinding functions. The resulting PAn-C composite has higher conductivity than the mixture of conductive carbon and PAn by direct mixing. The non-aqueous secondary organic battery of the present invention exhibits great capacity and energy density.

### BACKGROUND OF THE INVENTION

1. Field of the Invention

The present invention relates to the field of non-aqueous organic secondary battery production. In particular, the present invention relates to a non-aqueous organic secondary battery utilizing powders of conductive polymer-conductive carbon black composite as the positive electrode.

2. Description of the Related Art

An organic conjugated conductive polymer not only has the plasticity of a polymer, but also has the properties of a conductor or a semiconductor. Therefore organic conjugated conductive polymers are of high value in industrial applications. Until now, conductive polymers such as polyacetylenes (PA's), polypyrrroles (PPY's), poly-para-phenylenes (PPP's), polythiophenes (PT's), and polyanilines (PAn's) have been extensively studied. Conductivity of conductive polymers can be substantially raised by doping. Among the conducting polymers, PPP's in their doped states are very reactive to the atmosphere and humidity, and PPy's in their neutral state are very reactive to the atmosphere. PT's are not reactive to the atmosphere and humidity, and are very stable both in their doped and un-doped states. However, PT's have high self-discharge rate and is expensive.

Compared with previously mentioned conjugated conductive polymers, PAn's have the following features:

(1) cheap monomers and easy polymerization;

(2) very stable to the atmosphere and humidity;

(3) conductivity is not only adjustable through changing oxidation-reduction state, but is also adjustable via protonic acid doping without involving gaining or losing electrons.

(4) low self-discharge rate.

PAn's are therefore of great potential in a wide variety of applications. PAn's can be used in, for example, electrode materials based on their redox property; pH sensor device based on their proton-exchange property; monitor display based on their electrically sensitive color-changing property.

Generally speaking, methods for polymerizeing PAn's can be divided into chemical methods and electrochemical methods. In an electrochemical procedure, electric potential of a +0.8 V VS. saturate calomel electrode is applied to working electrode in an aniline aqueous containing a proton acid to form blackish green doped PAn on the platinum positive electrode. However, by applying the electrochemical method, it is difficult to pear off the formed PAn from the positive electrode plate, and PAn plate with large surface area can not be synthesized (D. M. Mohilner et al., J. Am. Chem. Soc., 84 (1962) 3618.) On the other hand, chemical polymerization of PAn usually involves adding (NH4)S₂O₈ as the oxidizer into an aniline aqueous containing a proton acid. Doped PAn precipitate is formed in the resulting black green aqueous. The PAn precipitate is then dedoped by washing with a base aqueous (eg., NH₄OH or NaOH) to obtain neutral PAn (A. G. MacDiarmid et al., Synth. Met., 13(1986)193.; W. W. Focke et al., J. Phys. Chem., 91(1987)5813.)

Goto et al. indicate that among PAn's, PAs, PPy's, and PTs, PAn has the best performance when applied in organic secondary battery due to its high energy density, high power density, high capacity efficiency, high cycle life, and low self-discharge.

Three types of organic secondary battery using PAn have been developed, and they are, (i) organic secondary batteries containing aqueous electrolyte (A. Kitani, M. Kaya, and S. Sasaki, J. Electrochem. Soc., 133(1986)1069; A. G. MacDiarmid et al., U.S. Pat. No. 5,023,149(1991)); (ii) organic secondary batteries containing non-aqueous electrolyte (E. M. Genies et al., Synthetic Metals, 18(1987)631; F. Goto et al., Synthetic Metals, 18(1987)365); and (iii) organic secondary batteries containing solid polymer electrolyte.

The negative electrode material of an organic secondary battery containing aqueous electrolyte is a metal with lower oxidization potential, for example, Zn and Al. The resulting open circuit voltage and energy density are lower, and therefore such battery has less practical use.

Lithium is often used as the negative electrode in an organic secondary battery containing non-soluble electrolyte. Due to high oxidization potential, light weight, and great ductility of lithium, such organic secondary battery has high open circuit voltage and high capacity per unit mass. An organic secondary battery containing non-soluble electrolyte usually has LiClO4 dissolved in propylene carbonate (PC) as the electrolyte aqueous. High dielectric constant and dipole moment of PC allow lithium salts to dissolve in PC easily. E. M. Genies, et al. utilized lithium, PAn, and LiClO4-PC aqueous to form a secondary battery, and found that the battery has an open circuit voltage of 3.6 V and energy density of 300 Wh/Kg.

As to an organic secondary battery containing solid state polymer electrolyte, gel polymer electrolyte system has been developed. Such electrolyte contains a plasticizer (70˜80 wt. %), which is a solvent with high dielectric constant. The plasticizer allows ions to move more freely, which in turn increases conductivity up to 10⁻³ S/cm, and enable low temperature operation. The practical use of polymer electrolyte is thus greatly improved. The most practical and popular plasticizers at the present time are poly(vinylidene fluoride) (PVdF) and polyacrylonitrile (PAN) due to their better physical properties such as conductivity, electrochemical stability, and mechanical strength over polycycloethylene (PEO) and poly(methyl methacrylate) (PMMA).

According to the references, manufacture of organic secondary batteries is carried out by the following methods:

(i) chemically synthesized PAn electrode plate: PAn is chemically synthesized. Doped state PAn powder is mixed with carbon black and binder. The mixture is pressed to form a plate, which is then further pressed to adhere to a metal network. The metal network is used as a collector (A. G. MacDiarmid et al., Synthetic Metals, 18(1987)393; E. M. Genies et al., J. Applied Electrochemistry, 18(1988)751; M. Mizumoto et al., Synthetic Metals, 28(1989) C639)∘

(ii) electrochemically synthesized PAn electrode plate: PAn film is formed on a metal substrate using electrochemical polymerization, wherein the metal substrate is used as a collector. The electrochemically synthesized PAn film has a porous fibrous structure similar to the structure of polyacetylene. The large specific surface area of such structure allows a larger contact area with electrolyte, and thus increases the diffusion rate within the film and the charge capacity of the battery. (F. Goto et al., J. Power Souces, 20(1987)243; S. Tangnshi et al., J. Power Source, 20(1987)249; E. M. Genies et al., Synthetic Metals. 29(1989)C647; Bridgestone Corp. U.S. Pat. No. 1,066,566(1991); Ricoh Corp. U.S. Pat. No. 4,999,263(1991); U.S. Pat. No. 4,948,685(1990).)

(iii) PAn electrode plate produced by casting: S.-A. Chen et al. in U.S. Pat. No. 5,667,913 disclose a method with the following steps: PAn is synthesized using the chemical method; the PAn in its neutral emeraldine base form is mixed with ionic salts and a conventional polymer such as poly (vinyl alcohol) in an organic solvent such as N-methyl-2-pyrrolidinone (NMP); the mixture is cast on a collector such as a nickel gauze or a metal plate to form an electrode plate. Such an electrode plate has high conductivity, desirable mechanical properties, and large contacting area.

However, there are certain drawbacks to each of these three types of PAn electrode plate:

(i) Chemically Synthesized PAn Electrode Plate

(a) Normally, acetylene black or carbon black is added into the positive electrode material to increase the conductivity. However, the addition of acetylene black or carbon black leads to segregation of carbon black and PAn. The uneven mixing of these two substances in turn hinders the active substance from effective utilization.

(b) The PAn plate and current collector are attached to each other by pressure or gluing. The PAn plate and current collector thus do not directly contact each other resulting in an increase of resistance within the electrode plate and reducing the battery's efficiency.

(c) The surface of a chemically synthesized PAn plate is denser than that of an electrochemically synthesized PAn plate, and has smaller contact area with electrolyte solution. This results in an increase of resistance to ion diffusion during charge/discharge and thus reduces the battery's efficiency.

(ii) Electrochemically Synthesized PAn Electrode Plate

(a) Large electrochemically synthesized PAn electrode plate is difficult to produce, and therefore is only used in button batteries.

(b) The electrochemical polymerization procedure of PAn is more complicated than the chemical polymerization procedure.

(c) Electrochemically synthesized PAn plates are brittle, and thus can not be used in producing flexible batteries.

(iii) PAn Electrode Plate Produced by Casting

(a) Producing PAn electrode plate by casting requires more concentrated PAn solution. However, at high concentration, PAn does not dissolve well in NMP. Moreover, casting with less concentrated PAn solution is undesirable in industrial application.

(b) This method is not suitable for high capacity battery production, since it can only produce thin PAn films but not thick PAn films as required in high capacity batteries.

The Bridgestone company in Japanese disclosed the making of PAn positive electrode of a button battery by electrochemically polymerizing PAn on a collector (U.S. Pat. Nos. 4,957,833 and 5,066,566). The resulting battery has a charge capacity of 80 Ah/kg. However, a battery with large surface area cannot be made using this method. Recently, another Japanese company, Ricoh, disclosed a method for making a PAn film with a thickness of 0.05 mm on a porous metal film by an electrochemical procedure (U.S. Pat. Nos. 4,999,263 and 4,948,685). The resulting film battery is 50 mm long, 50 mm wide and 0.9 mm thick, and has a energy density of 326 Wh/kg. This PAn film however, is brittle and can not be rolled up.

### SUMMARY OF THE INVENTION

The object of the present invention is to provide a non-aqueous organic secondary battery with increased charge capacity and energy density.

The present invention provides a novel organic secondary battery. More particularly, the present invention provides an organic secondary battery with a positive electrode plate containing a conductive polymer-conductive carbon black composite.

For example, an organic secondary battery can be formed using a positive electrode plate comprising a composite of PAn and conductive carbon black and a current collector, a lithium metal negative electrode, and an electrolyte solution of 1.0M LiCIO₄ in PC/EC. Such organic secondary battery has a capacity of 101 Ah/Kg, an energy density of 319 Wh/Kg, and a battery coulomb efficiency of 99% after 50 recharge discharge cycles. Both the capacity and energy density of this battery have an increase of about 50% over the battery having the positive electrode plate formed by mixing PAN and conductive substance such as graphite, acetylene black, or carbon black.

### DETAILED DESCRIPTION OF THE PREFERRED EMBODIMENT

Basically, the present invention introduces carbon black in the polymerization of aniline, during which the reacting particles are pulverized and dispersed using a high-speed impingement mill. The high-speed impingment mill provides high-speed fluid striking and grinding, which enables the formation of small particles of the conductive polymer-conductive carbon black composite without surfactant. This composite has higher conductivity than that form direct mixing of conductive carbon and PAN. In the positive electrode plate composed of the conductive polymer-conductive carbon black composite of the present invention, the carbon black particles are evenly distributed in the positive electrode and form a conductive path, which contact well with PAn. The conductivity of this conductive path will not decrease during the discharging process. This feature of such conductive polymer-conductive carbon black composite allows an increase of the utilization of the electrochemically active material in the positive electrode.

The conductive polymer of the present invention is selected from polypyrrroles (PPY's), poly-para-phenylenes (PPP's), polythiophenes (PT's), and polyanilines (PAn's). Monomers of the conductive polymer and conductive carbon black particles with small diameters are mixed and dispersed in a liquid medium by a high-speed impinging homogenizing mill. An initiator is slowly dropped into the medium and monomers are polymerized on the surface of the conductive carbon black. At the same time, the mixture is subjected to high-speed dispersion in a homogenizing mill. A conductive polymer-conductive carbon black composite is thus obtained. Due to small diameter (about 35 nm) and high surface tension with water, carbon black particles tend to aggregate in water. Therefore, the surface area of carbon black in contact with PAn during the polymerization process is reduced. To solve this problem, a surfactant is added to reduce the surface tension between carbon black and water. However, the surfactant added into the aqueous will form a thin film on carbon black and conductive polymer particles and therefore greatly reduces the conductivity and electrochemical activity of the resulting conductive polymer-carbon black composite.

The present invention utilizes a high-speed impinging homogenizing mill to achieve dispersed assembly of conductive polymers and carbon black without a surfactant, thus avoiding the problem of reduced conductivity and electrochemical activity.

The conductive polymer-carbon black composite of the present invention is mixed with adhesive thoroughly, rolled to form a sheet, which is then used in an positive electrode plate. The adhesive used is poly(terafluoroethylene) (PTFE) or any conventional polymers that can form ion conductor with metal salt, such as poly(vinyl alcohol) (PVA), poly(ethylene oxide) (PEO), poly(vinylidene-fluoride) (PVdF), poly(acetonitrile) (PAn), poly(methyl methacrylate) (PMMA) and others.

In the present invention, the negative electrode plate is lithium, lithium alloy, zinc, aluminum, graphite carbon or the mixture thereof.

The battery of the present invention has a non-aqueous electrolyte or a solid polymer electrolyte. The non-aqueous solvent for the electrolyte is cyclic carbonates, propylene carbonate, ethylene carbonate, butylene carbonate, acetonitrile, demethyl formamide, dimethyl sulfoxide, dimethoxyethane, or a mixture of non-cyclic carbonate and cyclic carbonate. The solid polymer electrolyte is polyethylene oxide, poly(vinylene-fluide), poly (acetonitrile), poly (methyl methacrylate), or a polymer thereof.

Carbon blacks available in the market have different properties due to the use of different raw material and manufacturing process. Through the use of high resolution electronic microscopy and X-ray structural analysis, it is shown that basic particles of carbon black are composed of graphite-like crystals that align concentrically. The layers of the crystalline graphite often exist in extreme disorder. That is, carbon black is an extremely disordered form of graphite carbon. The smallest unit of carbon black is called the “aggregate”, which has a chain-like or spherical structure. This structure cannot be destroyed by external force, and is known as the “basic” or “permanent” structure. The aggregates of carbon black aggregate with each other through physical forces to form agglomerates. The agglomerate structure is easily destroyed during manufacturing processes. The inter-connection and branching between the aggregates within an agglomerate is known as the “carbon black structure”, and is represented as the dibutylphthalate absorbance value (DBP absorbance value). Conductive carbon black is also known as highly structural carbon black due to its higher DBP absorbance value. It also contains less surface oxide, and therefore has smaller resistance. Such highly structural carbon black contains more basic particles per unit weight, and will occupy large space when the basic particles are dispersed, which in turn provides more contact points to form a conductive path.

The method of the present invention will be described using PAn as an example of conductive polymer.

Carbon black used in the present invention is conductive carbon black with a specific surface area of 1000 m²/g, a basic particle diameter of 35 nm, a DBP absorbance value of 400 ml/100 g, volatile substance less than 4%, conductivity greater than 0.1 S/cm, pH 8.5, solvent extract less than 0.1%.

The PAn polymer used in the present invention has the following chemical formula:

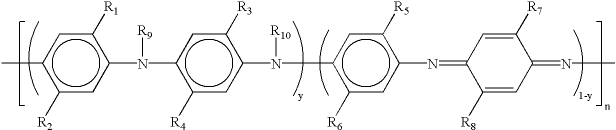

wherein R1 and R2 are respectively hydrogen, alkyl, alkoxyl, or aromatic groups.

The conductive polymer of the present invention can be optionally doped with metal salt selected from the group consisting of LiClO₄, LiBF₄, LiPF₆, LiSbF₆, LiI, LiBr, LiCl, LiAlCl₄, LiSCN, NaPF6, NaSbF₆ , NaAsF₆, NaClO₄, NaI, NaCl, KClO₄, and Zn(ClO₄)₂.

PAn-carbon black particle prepared under high-speed dispersion (Preparation Examples 3 and 4) is called PAn-carbon black (PAn-C) composite. Using such evenly dispersed PAn-C composite and a current collector as the positive electrode, a suitable metal such as lithium or alloy thereof as the negative electrode, and non-aqueous solution of metal salt or solid ionic conductor as the electrolyte, an organic secondary battery is formed.

The organic secondary battery of the present invention utilizes non-aqueous electrolyte. The solvent of the electrolyte is selected from cyclic carbonates such as propylene carbonate (PC), ethylene carbonate (EC) or butylene carbonate, or is selected from other organic solvent such as dimethoxyethane, acetonitrile, demethyl formamide, dimethyl sulfoxide, other lactones or esters, or mixtures of non-cyclic carbonate and cyclic carbonate. Due to their high dielectric constants and dipole moments, PC and EC dissolve salts easily and thus increase the efficiency of the battery. The concentration of such electrolyte is normally 0.2˜0.3 M.

To prevent a short circuit resulting from the contact between the positive electrode and negative electrode, a separator can be introduced between the positive and negative electrode of the battery (FIG. 1). The separator needs to be both insulating and porous to allow ions to pass through. Examples for material often used as a separator are porous polymers such as polypropylene, polyethylene, or fibric materials.

The organic secondary battery of the present invention uses lithium or alloy thereof as the negative electrode. Lithium has the highest oxidation potential and great ductility, negative electrode of an organic secondary provides high open circuit votage, also increases energy density of the battery. Nevertheless, when the safety of the battery is considered, using other material such as Li/Al alloy is a better choice. Alternatively, solid or gel electrolyte can be used to suppress lithium dendrite crystal growth. The embodiment of the present invention discloses efficiency of different positive electrode material. To reduce influence of other factors, examples present here using 1.0 M LiClO4-PC/EC solution as the liquid electrolyte, porous polypropylene as the separator, and lithium metal as the negative electrode. The batteries are of button type as shown in FIG. 1, wherein negative electrode 1, gasket 2, separator 3, and positive electrode 4 are indicated.

The present invention is essentially dispersing PAn and carbon black in an acidic aqueous. The carbon black is well dispersed using an impinging homogenizing mill in a liquid without using a surfactant, and thus allowing a good contact with PAn. During the polymerization, the high-speed impingment mill provides high-speed fluid striking and grinding functions enabling the formation of small particles of the PAn-C composite. This composite has higher conductivity than the composite of conductive carbon and PAn by direct mixing. An electrode made of this kind of composite does not have the problem of segregation of carbon black and PAn separately, which often occurs when carob black and PAn is mixed directly. During the discharge of a battery, the positive electrode undergoes a reduction reaction. That is, PAn is undoping during discharging. If only PAn is used to make a positive electrode, the conductivity of the positive electrode will gradually decrease during discharging. On the other hand, for a positive electrode made of PAn-C composite, the carbon black becomes a conductor evenly distributed throughout the positive electrode and forms a conductive path way. The conductivity of the PAn-C composite positive electrode does not decrease during discharging, and thus the active material of the positive electrode is fully utilized. The battery of the present invention thus has a higher energy density and higher capacity.

Without intending to limit it in any manner, the present invention can be more fully understood by reading the subsequent examples and references made to the accompanying drawings.

### BRIEF DESCRIPTION OF THE DRAWINGS

FIG. 1 is a schematic diagram of a button battery of an embodiment of the present invention.

FIG. 2 is a schematic diagram of a high speed impinging homogenizing mill.

FIG. 3 is a schematic diagram of a dispersion device of a impinging homogenizing mill.

FIG. 4 is a scanning electron micrography of conductive carbon black (60,000×).

FIG. 5 is a scanning electron micrography of PAn-conductive carbon black composite (5000×).

FIG. 6 is a scanning electron micrography of PAn-conductive carbon black composite (20,000×).

FIG. 7 is a diagram showing the performance of a button battery with an positive electrode as described in Preparation example 2 and Example 1.

FIG. 8 is a diagram showing the performance of a button battery with an positive electrode as described in Preparation example 3 and Example 2.

FIG. 9 is a diagram showing the performance of a button battery with an positive electrode as described in Preparation example 4 and Example 3.

FIG. 10 is a diagram showing the performance of a button battery with an positive electrode as described in Preparation example 5 and Example 4.

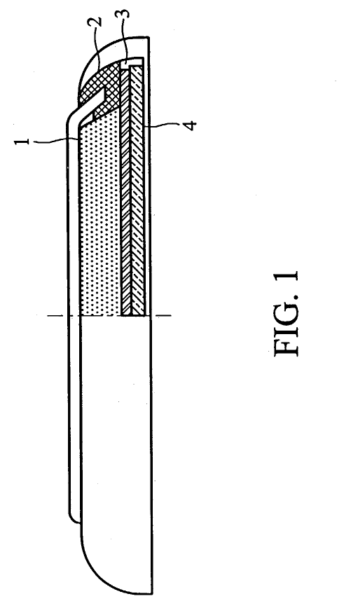

### PREPARATION EXAMPLE 1

Dispersion of Conductive Carbon Black

0.1 mol. aniline monormer (about 9.31 g) and 0.931 g of conductive carbon black was added to 200 ml 1.0 M HClO4 aqueous (mass ratio of conductive carbon black to PAn monor is 1:10) in a impinging homogenizing mill at 12500 rpm for 1 hour to get a evenly mixed aqueous of conductive carbon black and PAn.

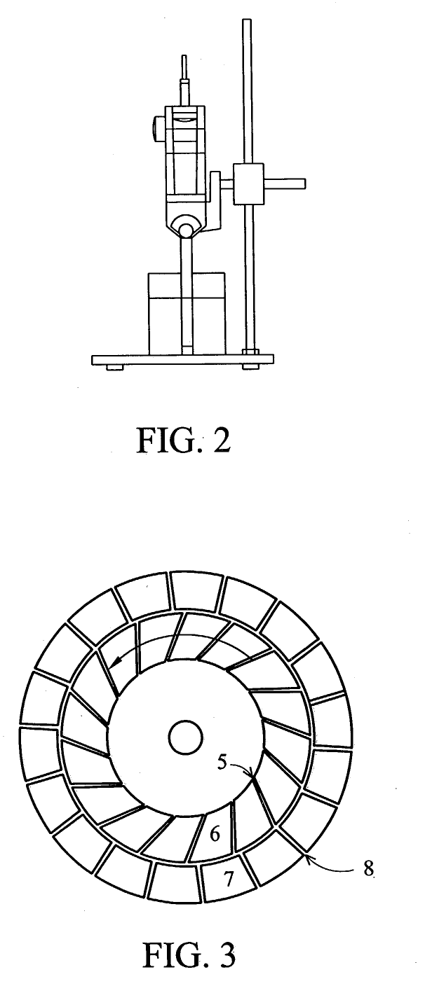

The impinging homogenizing mill (FIG. 2) utilizes high-speed striking and high speed rotation to disperse a medium. As shown in FIG. 3, a medium enters the mill from entrance 5 under rotor 6, and is sent through stator 7 by high speed rotation and exits from exit 8 (Patton T. C., Paint flow and pigment dispersion, John-Wiely & Sons, New York, 1978). Another function of stator 7 is to separate flow of the medium to avoid too much medium rotation. When dispersing a solid/liquid mixture, solid particles are sucked to the center of rotor 6, and then shot out. During this process, the solid particles strike the stator 7 with high speed and great force and thus break into finer particles.

The size of the resulting particles gets smaller when the speed of rotor 6 increases. The rotor used in this example has a diameter of 12.7 mm, the stator has a diameter of 18 mm. When the rotation speed was 12500 rpm, the speed at the outer edge of the rotor was about 8.31 m/s (1636.32 ft/min). The circular speed was 5.32 m/s (1047.25 ft/min) at the lowest speed of 8000 rpm. The circular speed was 15.9 m/s at the highest speed of 24000 rpm. It should be noticed that when the diameter of the rotor increases, the outer circular speed increases when the rotation speed is constant. A mill with a larger diameter also has the advantage of processing more material.

### PREPARATION EXAMPLE 2

Procedure for Making Doped PAn Powder

0.1 mol. aniline was dissolved in 200 ml 1.0 M HClO₄ aqueous with magnetite stirring. The ratio of oxidant/monomer in the aqueous, which is represented as r, is 1.5 or 1.0. 200 ml 1.0 M HClO₄ aqueous containing 0.15 mol (or 0.1 mol) NH₄)₂S₂O₈ was then added to the 0.1 mol aniline aqueous under nitrogen gas purging and ice bath. After a few hours of reaction, a blackish green precipitate of PAn was obtained, which was washed with 0.1 M HClO4 until the filtrate becomes colorless. The resulting product was dried in a vacuum for over 48 hours to get a doped PAn powder.

### PREPARATION EXAMPLE 3

Polymerization of PAn-C Composite

Carbon black was prepared in a similar process described in Preparation example 1 with magnetite stirring. 200 ml 1.0 M HClO4 aqueous containing the carbon black and 0.1 mol aniline was prepared. The ratio of oxidant/monomer in the aqueous, which is represented as r, was 1.5 or 1.0. 200 ml 1.0 M HClO₄ aqueous containing 0.15 mol (or 0.1 mol) NH₄)₂S₂O₈ was then added under nitrogen gas purging at room temperature. After a few hours of reaction, a dark precipitate was obtained, which was washed with 0.1 M HClO4 until the filtrate becomes colorless. The resulting product was dried in a vacuum for over 48 hours to give a doped PAn-C composite.

### PREPARATION EXAMPLE 4

Polymerization of PAn-C Composite

Carbon black was prepared in a similar process described in Preparation example 1 with high speed smash and dispersion in a impinging homogenizing mill. 200 ml 1.0 M HClO₄ aqueous containing the carbon black and 0.1 mol aniline was prepared. The ratio of oxidant/monomer in the aqueous, r, was 1.5 or 1.0. 200 ml 1.0 M HClO₄ aqueous containing 0.15 mol (or 0.1 mol) NH₄)₂S₂O₈ was then added under nitrogen gas purging at room temperature. After a few hours of reaction, a dark precipitate was obtained, which was washed with 0.1 M HClO4 until the filtrate colorless. The resulting product was dried in a vacuum for over 48 hours to give a doped PAn-C composite.

### PREPARATION EXAMPLE 5

Polymerization of PAn-graphite Composite

Graphite has a better conductivity than conductive carbon black does. A PAn-graphite composite was produced by the same procedure for producing PAn-C composite for comparison.

Graphite was prepared in a similar process described in Preparation example 1 with high speed smash and dispersion in a impinging homogenizing mill. 200 ml of 1.0 M HClO₄ aqueous containing the graphite and 0.1 mol aniline was prepared. The ratio of oxidant/monomer in the aqueous, r, was 1.5 or 1.0. 200 ml of 1.0 M HClO₄ aqueous containing 0.15 mol (or 0.1 mol) NH₄)₂S₂O₈ was then added under nitrogen gas purging at room temperature. After a few hours of reaction, a dark precipitate was obtained. The filtrate was washed with 0.1 M HClO4 until colorless. The resulting product was dried in a vacuum for over 48 hours to get a doped PAn-graphite (PAn-G) composite.

### PREPARATION EXAMPLE 6

Electrical Microscopy of Conductive Carbon Black and PAn-C Composite

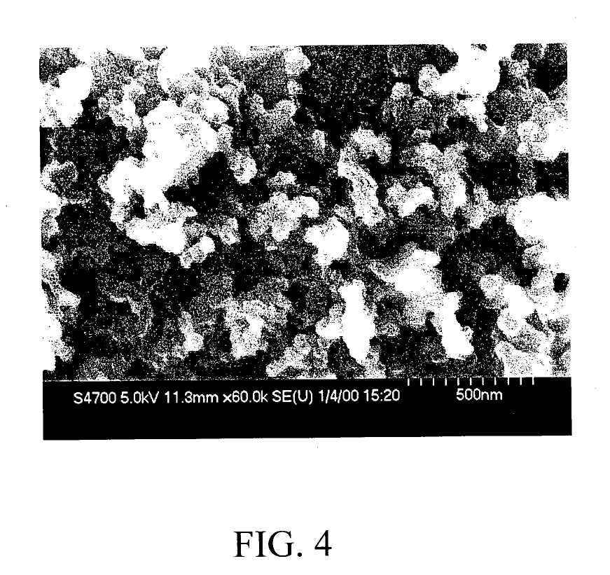

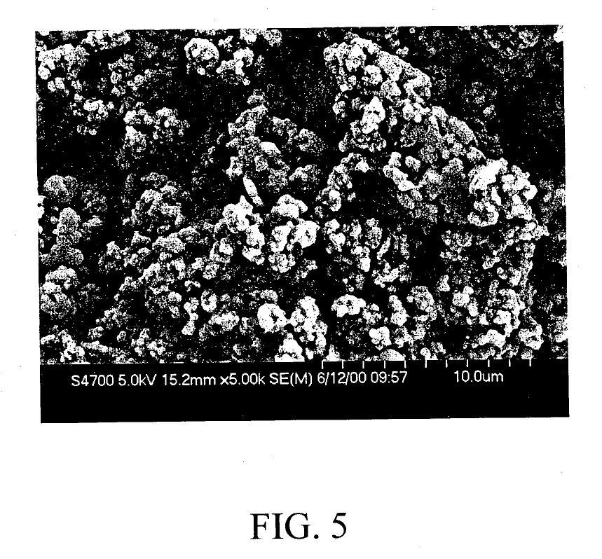

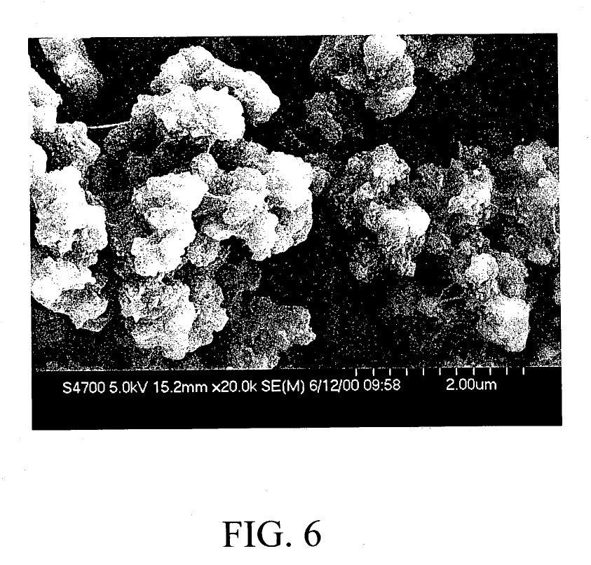

Basic particles of conductive carbon black are shown in FIG. 4. It is shown that basic particles of conductive carbon black are about 50 nm diameter, and tend to aggregate during string to yield chain-like structure. SEM diagrams of PAn-C composite are shown in FIGS. 5 and 6. PAn-C composite has a similar structure as that of conductive carbon black, but with larger diameter.

### PREPARATION EXAMPLE 7

Dissolving of PAn-C Composite in N-methyl-2-pyrrolidinone (NMP)

PAn-C composite was dissolved in NMP. When the composite was completely dissolved, the resulting PAn and carbon black can pass through a 0.45 μm filter.

Preparation examples 6 and 7 show a well distribution of conductive carbon black basic particles by use of impinging homogenizing mill, on which aniline monomers can polymerize to form PAn-C composite. During the polymerization, polymer particles so formed were also separated by the impinging homogenizing mill. Thus, the PAn and carbon black particles were evenly mixed in the resulting PAn-C composite. That is, the contact between PAn and carbon black particles is approaching molecular level.

### PREPARATION EXAMPLE 8

Condutivity Test

Powders of conductive carbon black, graphite, and doped PAn from Preparation examples 2, 3, 4, and 5 were pressed into tablets. The conductivity of the tablets was tested using the 4-probe method and the results are shown in Table 1. The conductivity of the conductive carbon black used herein was 30 S/cm, and that of graphite was 1828 S/cm. To compare PAn with different doping levels, the doped PAn was washed with HClO₄ or DI-water. As shown in Table 1, PAn washed with DI-water had a lower doping level and lower conductivity. On the other hand, PAn-C composite washed with DI-water maintained a good conductivity despite of decreased doping level. PAn-C composite washed with DI-water has a conductivity of about 15-40 times that of PAn indicating that the addition of conductive carbon black increases the conductivity. This effect is more obvious when the doping level of PAn-C composite is lower. Since carbon black is evenly distributed and in good contact with PAn, a PAn-C composite positive electrode maintains good conductivity despite the undoping of PAn during battery discharge. The charge/discharge efficiency, capacity, and energy density of the battery are therefore increased.

TABLE 1

| Polymerization condition | | conductivity (S/cm) |
|---|---|---|
| PAn, r = 1.5, | 0.1 N HClO4 | 55 |
| Magnetite stirring | DI-water | 0.24 |
| PAn-C(10%), r = 1.5, | 0.1 N HClO4 | 38.2 |
| High speed dispersion | DI-water | 8.8 |
| PAn-C(5%), r = 1.5, | 0.1 N HClO4 | 35.5 |
| High speed dispersion | DI-water | 7.1 |
| PAn-C(10%), r = 1.0, | 0.1 N HClO4 | 69.1 |
| High speed dispersion | DI-water | 10.2 |
| PAn-C(5%), r = 1.0, | 0.1 N HClO4 | 73.9 |
| High speed dispersion | DI-water | 4.3 |
| PAn-G(10%), r = 1.5, | 0.1 N HClO4 | 90.5 |
| High speed dispersion | | |

Numbers in brackets represent weight percent of conductive carbon black to PAn during polymerization.

### EXAMPLE 1

Battery with a PAn Positive Electrode

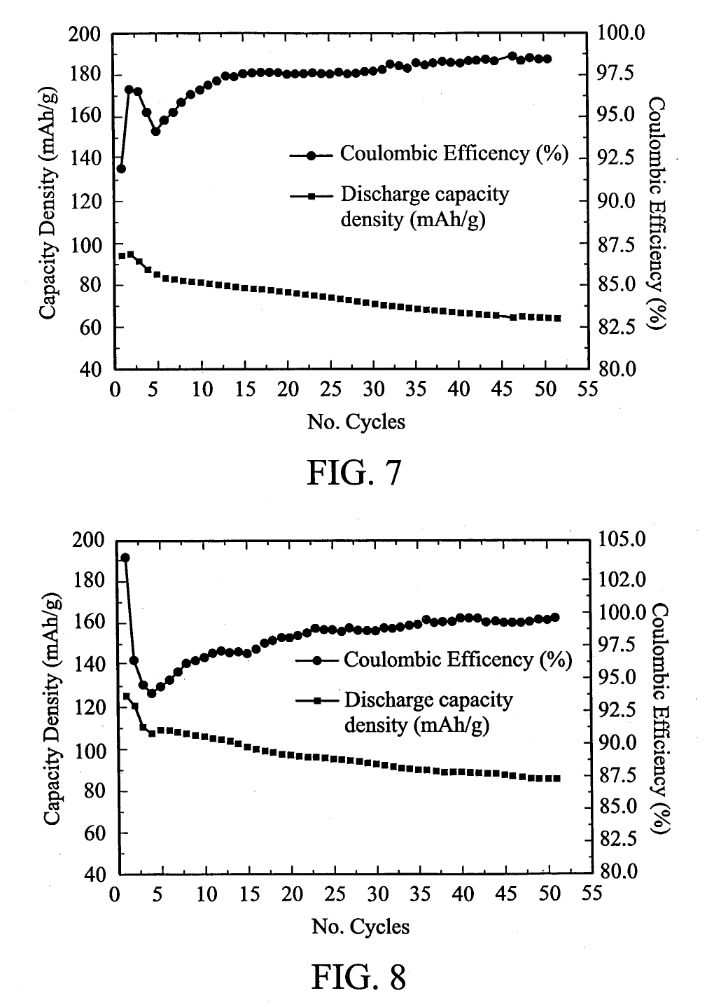

PAn powder obtained in Preparation example 2 was mixed with adhesive and graphite, and pressed into an positive electrode film with a surface area of 1.76 cm² and a desired thickness. A button type battery with this positive electrode film and a lithium negative electrode was made. Charge/discharge was carried out with a current of 0.5 mA, the upper limit of charge voltage was 4.0 V, the lower limit of discharge voltage was 2.5 V. After 10 cycles of charge/discharge, the capacity was 80.93 mAh/g, energy density was 264.05 Wh/Kg, coulomb efficiency was 96.7%. After 50 cycles of charge/discharge, the capacity was 63.46mAh/g, energy density was 207.36Wh/Kg, coulomb efficiency was 98.5% (please refer to FIG. 7). The highest capacity was 94.54 mAh/g.

### EXAMPLE 2

Battery with a Magnetite Stirred PAn-C Composite Positive Electrode

PAn-C composite powder obtained in Preparation example 3 was mixed with adhesive and graphite, and pressed into an positive electrode film with a surface area of 1.76 cm² and a desired thickness. A battery with this positive electrode film and a lithium negative electrode was made. Charge/discharge was carried out with a current of 0.5 mA, the upper limit of charge voltage was 4.0 V, the lower limit of discharge voltage was 2.5 V. After 10 cycles of charge/discharge, the capacity was 103.84 mAh/g, energy density was 327.54 Wh/Kg, coulomb efficiency was 96.1%. After 50 cycles of charge/discharge, the electric capacity was 83.12 mAh/g, energy density was 265.69 Wh/Kg, coulomb efficiency was 98.8% (please refer to FIG. 8). The highest capacity was 123.63 mAh/g.

### EXAMPLE 3

Battery with PAn-C Composite Prepared Using High Speed Dispersion as Positive Electrode

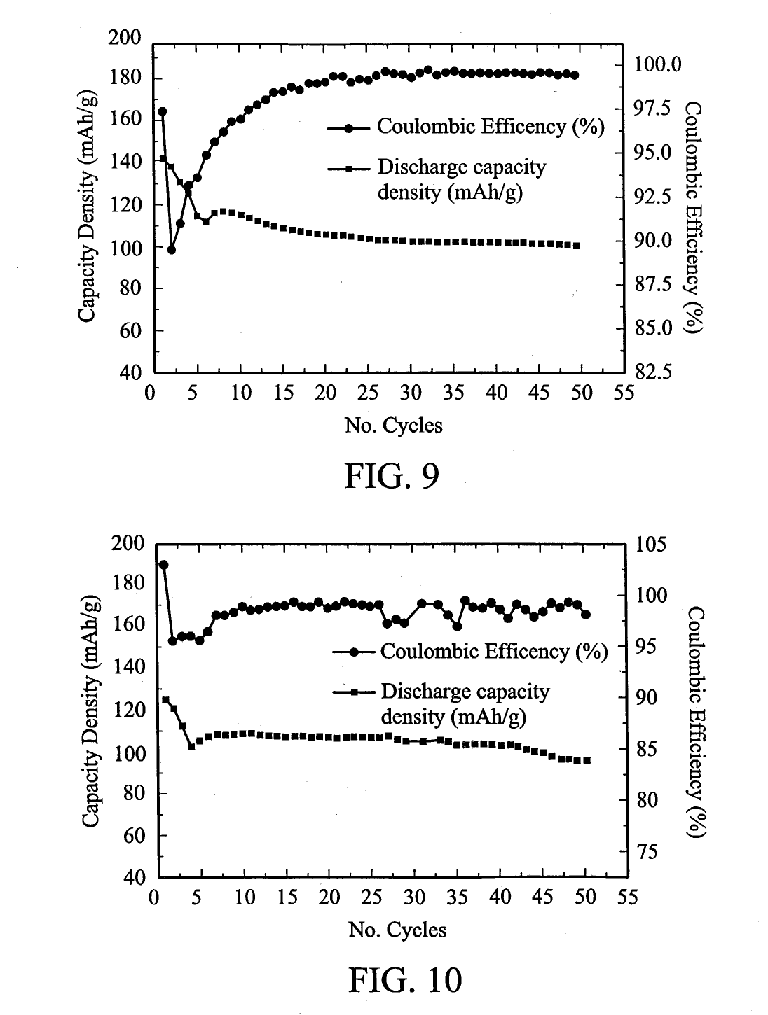

PAn-C composite powder obtained in Preparation example 4 was mixed with adhesive and carbon black, and pressed into an positive electrode film with a surface area of 1.76 cm² and a desired thickness. A button type battery with this positive electrode film and a lithium negative electrode was made. Charge/discharge was carried out with a current of 1.5 mA, the upper limit of charge voltage was 4.0 V, the lower limit of discharge voltage was 2.5 V. After 10 cycles of charge/discharge, the electric capacity was 115.55 mAh/g, energy density was 363.98 Wh/Kg, coulomb efficiency was 96.6%. After 50 cycles of charge/discharge, the capacity was 100.59 mAh/g, energy density was 318.46 Wh/Kg, coulomb efficiency was 99.1% (please refer to FIG. 9). The highest electric capacity was 142.42 mAh/g.

### EXAMPLE 4

Battery with PAn-Graphite Composite Prepared Using High Speed Dispersion as Positive Electrode

PAn-G composite powder obtained in Preparation example 5 was mixed with adhesive and graphite, and pressed into an positive electrode film with a surface area of 1.76 cm² and a desired thickness. A button type battery with this positive electrode film and a lithium negative electrode was made. Charge/discharge was carried out with a current of 1.5 mA, the upper limit of charge voltage was 4.0 V, the lower limit of discharge voltage was 2.5 V. After 10 cycles of charge/discharge, the electric capacity was 108.64 mAh/g, energy density was 343.19 Wh/Kg, coulomb efficiency was 98.9%. After 50 cycles of charge/discharge, the capacity was 94.41 mAh/g, energy density was 298.7 Wh/Kg, coulomb efficiency was 99.23% (please refer to FIG. 10). The highest electric capacity was 125.14 mAh/g.

### EXAMPLE 5

Comparison of Various Positive Electrodes

A battery with the PAn-C composite positive electrode of the present invention exhibited an efficiency nearly as good as a lithium ion battery.

TABLE 2

| | LiCoO₂ | LiNiO₂ | LiMn₂O₄ | PAn-C |
|---|---|---|---|---|
| Theoretical | 275 | 274 | 148 | 148 |
| capacity (mAh/g) | | | | |
| Average voltage (V) | 3.6 | 3.5 | 3.8 | 3.6 |
| Actual capacity | 140 | 180 | 130 | 134 |
| (mah/g) | | | | |
| O₂ release when over | yes | yes | no | no |
| charged | | | | |

The efficiency of the batteries with different positive electrodes of Examples 1 to 4 were compared after 50 charge/discharge cycles. It is clear that the addition of conductive carbon black to PAn during polymerization increases battery capacity and energy density by 50%. The efficiency of the PAn-G composite positive electrode was not as good as the PAn-C composite positive electrode when the production conditions were the same. Accordingly, the present invention provides a secondary organic battery with increased energy density and electric capacity. The present invention also improves the utilization of PAn, and thus the resulting battery is competitive with a lithium ion battery.

Finally, while the invention has been described by way of examples and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A non-aqueous secondary organic battery comprising:
an positive electrode plate composed of a metal plate as a current collector, a conductive film composed of PAn-conductive carbon black composite and adhesive;
a negative electrode plate composed of the lithium or alloy foil; and
non-aqueous electrolyte solution or solid polymer electrolyte.

2. The non-aqueous secondary organic battery as set forth in claim 1, wherein the polymer is polyaniline, polypyrrole, or polythiophene.

3. The on-aqueous secondary organic battery as set forth in claim 3, wherein the polyaniline has a chemical formula as follows: 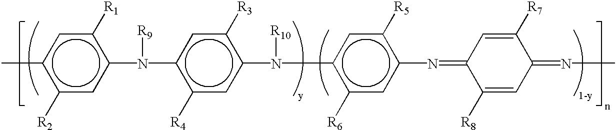
wherein R1 and R2 are respectively hydrogen, alkyl, alkoxyl, or aromatic groups.

4. The non-aqueous secondary organic battery as set forth in claim 1, wherein the conductive carbon black has a surface area ratio larger than 1000 m²/g, a dibutylphthalate absorbance value greater than 100 ml/100 g, volatile substance less than 10%, conductivity greater than 0.1 S/cm.

5. The non-aqueous secondary organic battery as set forth in claim 1, wherein the positive electrode is produced by:
(a) mixing the monomer of conductive polymer and conductive carbon black in a aqueous with high speed smash and dispersion to give a mixture of monomer and conductive carbon black;
(b) producing a powder of polymer conductive carbon black composite using the mixture from step (a) as the starting material; and
(c) mixing the powder of polymer monomer-conductive carbon black composite with adhesive, and pressing the mixture into a positive electrode plate of desired thickness.

6. The non-aqueous secondary organic battery as set forth in claim 5, wherein high speed smash and dispersion in step (a) is carried out with an impingement mill.

7. The non-aqueous secondary organic battery as set forth in claim 1, wherein the metal plate is stainless steel, nickel foil, aluminum foil, copper foil, or platinum plate.

8. The non-aqueous secondary organic battery as set forth in claim 1, wherein the metal plate is made by plating.

9. The non-aqueous secondary organic battery as set forth in claim 1, wherein the adhesive is poly(terafluoroethylene), (vinyl alcohol), poly(ethylene oxide), poly(vinylidene-fluoride), poly(acetonitrile), or poly(methyl methacrylate).

10. The non-aqueous secondary organic battery as set forth in claim 1, wherein the conductive polymer is doped with the salt: LiClO₄, LiBF₄, LiPF₆, LiSbF₆, LiI, LiBr, LiCl, LiAlCl₄, LISCN, NaPF₆, NaSbF₆ , NaAsF₆, NaClO₄, NaI, NaCl, KClO₄, or Zn(ClO₄)₂.

11. The non-aqueous secondary organic battery as set forth in claim 1, wherein the negative electrode plate is lithium, lithium alloy, zinc, aluminum, graphite carbon or a mixture thereof.

12. The non-aqueous secondary organic battery as set forth in claim 1, wherein the negative electrode plate is lithium alloy.

13. The non-aqueous secondary organic battery as set forth in claim 1, wherein the non-aqueous electrolyte is produced by dissolving metal salt in a non-aqueous solvent.

14. The non-aqueous secondary organic battery as set forth in claim 13, wherein the metal salt is LiClO₄, LiBF₄, LiPF₆, LiSbF₆, LiI, LiBr, LiCl, LiAlCl₄, LiSCN, or LiAsF₆.

15. The non-aqueous secondary organic battery as set forth in claim 13, wherein the non-aqueous solvent is cyclic carbonates, propylene carbonate, ethylene carbonate, butylene carbonate, acetonitrile, demethyl formamide, dimethyl sulfoxide, dimethoxyethane, or a mixture of non-cyclic carbonate and cyclic carbonate.

16. The non-aqueous secondary organic battery as set forth in claim 1, wherein the solid polymer electrolyte is polyethylene oxide, poly(vinylene-fluide), poly (acetonitrile), poly (methyl methacrylate), or a polymer thereof.
